(19) United States
(12) Patent Application Publication
(10) Pub. No.: US 2021/0043106 A1
(43) Pub. Date: Feb. 11, 2021

(54) TECHNOLOGY BASED LEARNING PLATFORM FOR PERSONS HAVING AUTISM

(71) Applicant: COGNITIVEBOTICS Technologies Pvt. Ltd., Hyderabad (IN)

(72) Inventors: Meenakshi Kumar Kotra, Hyderabad (IN); Jerry Thomas, Hyderabad (IN); Naga Mohan Kumar, Hyderabad (IN); Rajasekhar Reddy Jonnalagadda, Hyderabad (IN)

(21) Appl. No.: 16/947,179

(22) Filed: Jul. 22, 2020

(30) Foreign Application Priority Data
Aug. 8, 2019 (IN) 201941032153

(51) Int. Cl. G09B 19/00; G09B 9/00; G09B 7/06; G06F 3/14

(52) U.S. Cl. CPC G09B 19/00; G09B 9/00; G06F 3/013; G06F 3/14; G09B 7/06

(57) ABSTRACT

Aspects of the present disclosure are directed to providing a technology based learning platform for persons having autism. According to an aspect, skills of interest for a user are identified. The user is then aided in acquiring each of the identified skills. The progress of the user for each skill is monitored and a dashboard is provided to display the progress of the user for the skills.

### PRIORITY CLAIM

The instant patent application is related to and claims priority from the co-pending India provisional patent application entitled, “ELECTRONIC PLATFORM AIDING PERSONS HAVING AUTISM”, Serial No.: 201941032153, Filed: 8 Aug. 2019, naming as inventors Meenakshi Kumar Kotra et al, attorney docket number: COGB-301-INPR, which is incorporated in its entirety herewith.

### BACKGROUND OF THE DISCLOSURE

### Technical Field

The present disclosure relates to autism and more specifically to a technology based learning platform for persons having autism.

### Related Art

Autism is a developmental disorder that affects communication and interaction abilities in a person suffering with the disorder. Persons having autism may struggle with deficiencies in focus, attention span, memory and other related issues.

Technologies such as computer (including mobile phones, tablets, laptops, etc.) based games have been provided to aid person with autism to learn skills to overcome some of the deficiencies noted above. However, the inventors have realized that the state of art does not adequately extend the technologies for comprehensively addressing the various learning needs of person with autism. Aspects of the present disclosure are directed to technological improvements that aid individuals with autism in learning.

### BRIEF DESCRIPTION OF THE DRAWINGS

Example embodiments of the present disclosure will be described with reference to the accompanying drawings briefly described below.

FIG. 1 is a block diagram illustrating an example environment (computing system) in which several aspects of the present disclosure can be implemented.

FIG. 2 is a flow chart illustrating the manner in which a technology based platform is provided for persons with autism according to an aspect of the present disclosure.

FIGS. 3A-3D depict sample user interface provided to users to perform initial set up on the technology based learning platform in an embodiment.

FIGS. 4A-4K depict sample user interface provided to users for acquiring skills in an embodiment.

FIGS. 5A-5C depict sample dashboard provided to users for monitoring progress in an embodiment.

FIG. 6 is a block diagram illustrating the details of a digital processing system in which various aspects of the present disclosure are operative by execution of appropriate executable modules.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE EMBODIMENTS OF THE DISCLOSURE

1. Overview

Aspects of the present disclosure are directed to providing technological improvements aiding persons having autism to learn skills.

According to an aspect, skills of interest for a user are identified. The user is then aided in acquiring each of the identified skills. The progress of the user for each skill is monitored and a dashboard is provided to display the progress of the user for the skills. It may be appreciated that each user may have a different requirement of skills based on his/her surroundings. The technology based learning platform provides the flexibility to identify a set of skills for each user instead of having a predefined fixed set of skills for all users.

In an embodiment, as part of the aiding process in acquiring each skill, audio content and visual content is rendered for explaining the skill, for training a vocabulary associated with the skill and for simulating real world experiences for the skill.

According to another aspect, a mode of interaction is received for the user. The mode of interaction may be used for displaying interaction information and accepting response options from the user. The mode may be one or more of picture (e.g. for non-verbal users), audio (e.g. verbal but unable to read/write) and text, depending on the communication ability of the user.The mode of interaction for the user may be specified by the guardian/therapist of the user on the technology based learning platform.

According to yet another aspect, the audio content and the video content on the technology based learning platform are personalized for the user. The name of the user, a voice sample of a person familiar to the user and text corresponding to the audio content are received. The text is synthesized using the voice sample to form the audio content. The interaction questions, prompts and instructions are prefixed with the name of the user.

According to another aspect, facial images of a person familiar to the user in different human emotions are received. The facial images are then mapped to a set of pre-defined human emotions. The facial image of a desired human emotion is displayed to the user when the desired human emotion needs to be expressed.

In an embodiment, real world experiences are simulated on the technology based learning platform using virtual reality tools. For example, as part of aiding in acquiring the skill of sitting tolerance, a first hologram is created from a first image by the virtual reality tool. The first hologram is displayed to the user. It is determined whether the user is sitting in a first time duration. If the user is determined to be sitting, the first hologram is continued to be displayed during the first time duration. If the user is determined not to be sitting, the display of the first hologram is discontinued during the first time duration.

As another example, as part of aiding in acquiring the skill of maintaining appropriate physical distance, a second hologram is created from a second image by the virtual reality tool.The second hologram is displayed to the user. A distance of the user from the second hologram is determined by the virtual reality tool. If the distance is determined to be less than a minimum distance, the user is indicated to increase the distance.

As yet another example, as part of aiding in acquiring the skill of establishing eye contact, a third hologram is created from a third image by the virtual reality tool. A line of vision of the user is determined and the third hologram is displayed to the user outside the line of vision. The user is instructed to look at the third hologram. It is checked whether the user has looked in the direction of the hologram in response to the instruction.

According to another aspect, it is detected if the user is gazing at an object on a display screen. If the user is detected to be gazing at the object, it is concluded that the user is progressing with the ability to gaze. If the user is detected not to be gazing at the object, the user is indicated to gaze at the object.

Yet another aspect of the present invention presents a question to the user with indication of a corresponding correct answer. Only the correct answer is displayed and highlighted in an early phase of acquiring the skill. Additional options, including the correct answer, are displayed in subsequent phases of acquiring the skill. The correct answer is highlighted and/or shown in a size different from the rest of the options.

One more aspect of the present invention measures a duration spent by the user in acquiring the skill as part of monitoring the progress of the user in the skill. In an embodiment, the duration includes—a meaningful interaction time, an irrelevant interaction time and an idle time. The meaningful interaction time is computed based on a count of touch, mouse clicks and keyboard strokes inside a designated area on the display screen in a second time duration.The irrelevant interaction time is computed based on a count of touch, mouse clicks and keyboard strokes outside the designated area in the second time interval.

In an embodiment, the monitoring for each skill may be performed based on (but not limited to) metrics such as time taken to give responses, a number of correct responses of the user, a duration spent in acquiring the skill, a number of time-outs during learning sessions, etc. The aiding process of the user may be altered based on the progress. For example, the number of visual cues and audio prompts may be reduced if the progress exceeds a pre-defined threshold value. Alternatively or in addition, the mode of interaction may be changed (e.g. from audio to text) based on the progress. In an embodiment, each skill is determined to be acquired based on a threshold number of consecutive correct responses during the aiding process.

Several aspects of the present disclosure are described below with reference to examples for illustration. However, one skilled in the relevant art will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

2. Example Environment

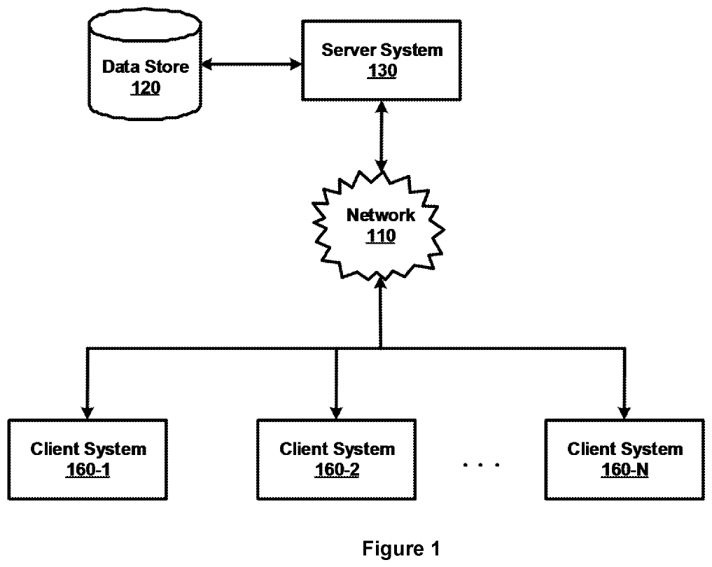

FIG. 1 is a block diagram illustrating an example environment (computing system) in which several aspects of the present disclosure can be implemented. The block diagram is shown containing network 110, data store 120, server system 130 and client systems 160-1 to 160-N (N representing any arbitrary positive number). Client systems 160-1 to 160-N are collectively or individually referred by referral numeral 160, as will be clear from the context.

Merely for illustration, only representative number/type of systems are shown in FIG. 1. Many environments often contain many more systems, both in number and type, depending on the purpose for which the environment is designed. Each block of FIG. 1 is described below in further detail.

Network 110 provides connectivity between client systems 160-1 to 160-N and server system130, and may be implemented using protocols such as Transmission Control Protocol (TCP) and/or Internet Protocol (IP), well-known in the relevant arts. In general, in TCP/IP environments, a TCP/IP packet is used as a basic unit of transport, with the source address being set to the TCP/IP address assigned to the source system from which the packet originates and the destination address set to the TCP/IP address of the target system to which the packet is to be eventually delivered.

An IP packet is said to be directed to a target system when the destination IP address of the packet is set to the IP address of the target system, such that the packet is eventually delivered to the target system by network 110. When the packet contains content such as port numbers, which specifies the destination application, the packet may be said to be directed to such application as well. The destination system may be required to keep the corresponding port numbers available/open, and process the packets with the corresponding destination ports. Network 110 may be implemented using any combination of wire-based or wireless mediums.

Data store 120 represents a non-volatile (persistent) storage facilitating storage and retrieval of a collection of data by server system 130. Data store 120 may be implemented as a database server using relational database technologies and accordingly provide storage and retrieval of data using structured queries such as SQL (Structured Query Language). Alternatively or in addition, data store 120 may be implemented as a file server providing storage and retrieval of data in the form of files organized as one or more directories, as is well-known in the relevant arts.

Each of client systems 160-1 to 160-N represents a corresponding end user system such as a personal computer, workstation, mobile station, mobile phones, computing tablets, etc.used by end users to generate (user) requests directed to the technology based learning platform application executing on server system 130.In general, client system 160 sends a user request containing one or more tasks and may receive the corresponding responses (e.g., embedded in web pages) containing the results of execution of the tasks. The web pages/responses may then be presented to the user at client systems 160 by client applications such as the browser.

Server system 130 represents a central server such as a web/application server, executing one or more software applications. Server system 130 may aid client systems to access the technology based learning platform. In an embodiment, server system 130 operates to provide a web application/portal for the technology based learning platform.

Server system 130 receives a user request from a client system 160 and performs the tasks requested (in the user request). Server system 130 may use data stored internally (for example, in a non-volatile storage/hard disk within the server), external data (e.g., maintained in data store 120) and/or data received from external sources (e.g., from the user) in performing the requested tasks. Server system 130 then sends the result of performance of the tasks to the requesting client system (one of 160) as a corresponding response to the user request. The results may be accompanied by specific user interfaces (e.g., web pages) for displaying the results to the requesting user.

In embodiments described below, server system 130 is assumed to operate based on machine learning, natural language processing and artificial intelligence capabilities.

The manner in which technology based learning platform aids persons with autism is explained below.

3. Flowchart

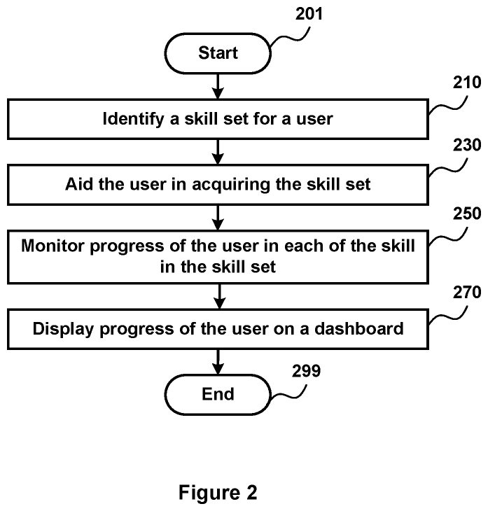

FIG. 2 is a flowchart illustrating the manner in which technology based learning platform is provided for persons having autism according to an aspect of the present disclosure. The flowchart is described with respect to the systems of FIG. 1 merely for illustration. However, many of the features can be implemented in other systems and/or other environments also without departing from the scope and spirit of several aspects of the present disclosure, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present disclosure.

It may be noted that persons with autism may need assistance in using the technology based learning platform. Therefore, a guardian/therapist may assist the person with autism to use the technology based learning platform. Accordingly, any of guardian or therapist or person with autism may be the user of the technology based learning platform in their respective contexts. The term ‘user’ may thus represent any of the three people, as will be apparent from the context. A guardian/therapist may have several associated persons with autism each of whom may use the technology based learning platform.

The flow chart begins in step 201, in which control immediately passes to step 210.

In step 210, a skill set is identified for a user. The skill set may be identified by the guardian/therapist from a pre-defined superset of skills provided on the technology based learning platform. The skill set may be identified based on the current abilities and requirements of the user. For example, skills ‘eye contact’ and ‘appropriate physical distance’ may be identified to be included in the skill set. Server system 130 may store the identified skill set in data store 120. Control passes to step 230.

In step 230, server system 130 aids the user in acquiring each skill of the skill set identified in step 210 above. Server system 130 may create a learning program based on the identified skill set. The learning program may have several learning modules for each skill, with each learning module aimed to teach a specific aspect of the skill acquisition. The learning modules may employ corresponding components (not shown) of server system 130 in order to complete the respective task.

In an embodiment, the learning modules may include a concept module used to explain the meaning of the skill to the user using audio content and visual content. This may be followed by a vocabulary module to train the vocabulary associated with the skill. Thereafter, a games module may aid the user to internalize the skill using games. In addition, there may be an optional association module to simulate real world experiences for the skill. In an embodiment, server system 130 may use mixed reality tools to simulate real world scenarios by creating three-dimensional objects.Server system 130 may also personalize the audio content and video content using voice samples and/or images provided by guardian/therapist. There may be fewer or more number of learning modules in the learning program, as will be apparent to a skilled practitioner.

It may be appreciated that server system 130 may alter the sequence of learning modules for a skill. For example, the vocabulary module may be presented first, followed by the concept module for a skill. Also, as part of acquiring a skill, each learning module may be repetitively presented to the user to ensure retention of the corresponding aspect of the skill. Control passes to step 250.

In step 250, server system 130 monitors progress of the user in acquiring each skill of the skill set. Server system 130 performs the monitoring based on (but not limited to) metrics such as time taken to give responses, a number of correct responses of the user, a duration spent in acquiring the skill, a number of time-outs during learning sessions, etc. In an embodiment, a user may need to achieve a certain pre-defined percentage of success (computed based on the above metrics) in each learning module in order to progress to the next module of the skill. In an embodiment, server system 130 determines each skill to be acquired based on a threshold number of consecutive correct responses during the aiding process. It may be appreciated that there may be other criteria to determine that a skill is acquired, as will be apparent to a skilled practitioner. Control passes to step 270.

In step 270, server system 130 displays a dashboard to guardian/therapist to view the progress of the user for each skill of the skill set. The dashboard may display module-wise progress and an overall progress for each skill. The dashboard may be viewed on client system 160. The flowchart ends in step 299.

Thus, the flowchart of FIG. 2 operates to provide a technology based learning platform for persons having autism.

It may be appreciated that some of the steps of the above flowchart may be executed in parallel. For example, steps 230, 250 and 270 may be executed in parallel. In other words, the guardian/therapist may view the progress of the user for each skill on a daily basis while server system 130 aids the user in acquiring the skill and monitors progress for the skill.

The description is continued with respect to the manner in which an initial set up is performed by a guardian/therapist in an illustrative embodiment, according to aspects of the present disclosure.

4. Initial Set Up

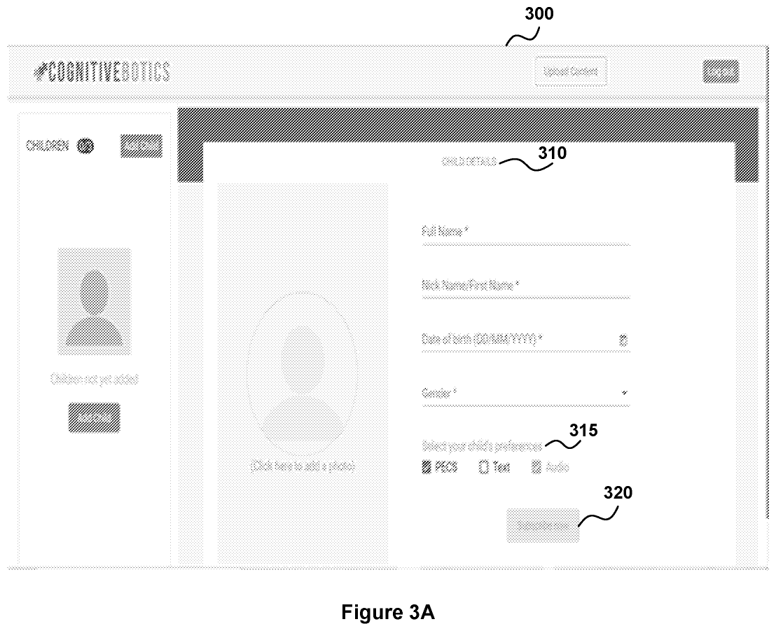

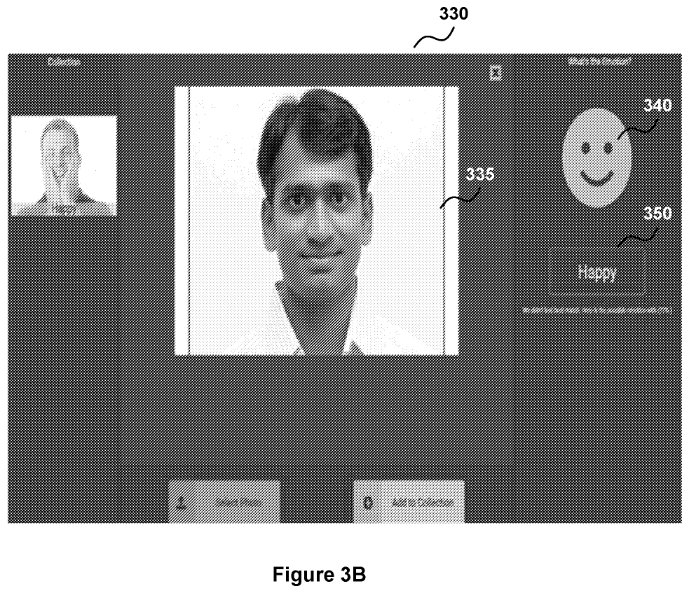

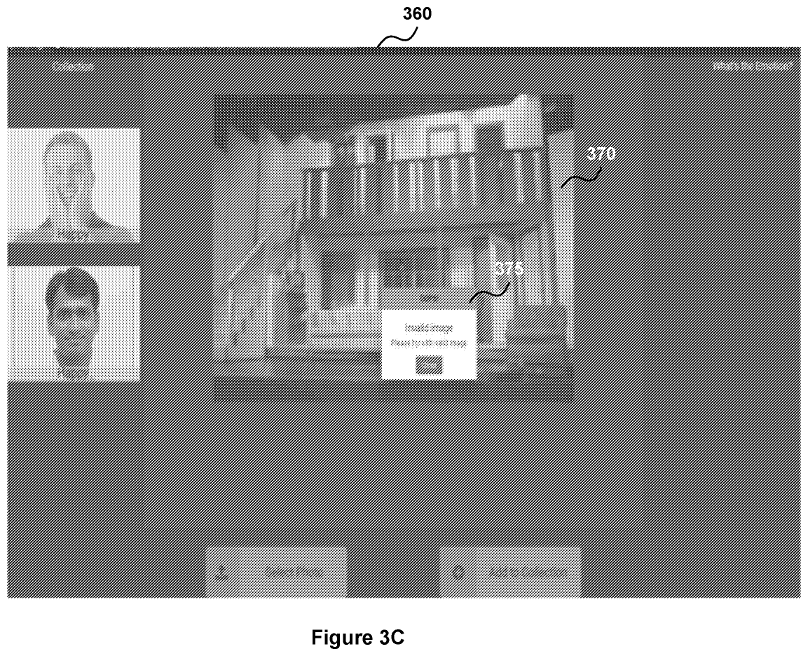

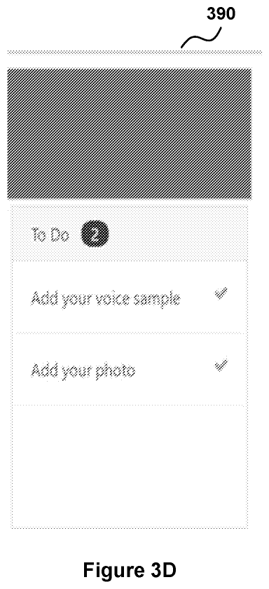

FIGS. 3A-3D depict sample user interface provided to users for performing initial set up in an embodiment. Only a few user interfaces as relevant to the understanding of the disclosure have been described in the embodiments below. The technology based learning platform may contain several other user interfaces as is well known in the relevant arts.

As noted above, any of a guardian, a therapist or a person with autism could be the user of the technology based learning platform at any given time in their respective contexts. The term ‘user’ may accordingly represent any of the three people, as will be apparent from the context. A guardian/therapist may have several associated persons with autism each of whom may use the technology based learning platform for acquiring respective skills.

It may also be appreciated that although the illustrative embodiment and some of the sample user interfaces are described with respect to a child with autism, the technology based learning platform may be used by persons with autism in general.

FIG. 3A depicts a sample user interface provided to users for enrolling a person with autism on the technology based learning platform. Specifically, FIG. 3A is shown containing screen 300 with an input area 310, preferences selection area 315 and ‘Subscribe now’ button 320.

Input area 310 may be used to provide details of the person with autism such as full name, date of birth, etc. Although only a few fields are shown in the illustrative user interface, it will be apparent to a skilled practitioner that there may be many more fields to gather details of the person with autism. This user interface may be provided to the user after successful registration (not shown) on the technology based learning platform, as is well known in the relevant arts.

Preferences selection area 315 may be used to specify one or more modes of interaction for the person with autism during the learning process—pictures (for non-verbal person with autism), text and audio formats by selecting the options in preferences list 315. As shown in FIG. 3A, the user has specified pictures and audio as the preferred modes of interaction. Based on the input from the user, the learning process may be planned for the person with autism. On clicking ‘Subscribe now’ button 320, the details of the person with autism may be saved to data store 120. There may be several categories of subscriptions (e.g. basic/premium) with corresponding features available, as is well known in the relevant arts.

The user may also upload images and/or videos in order to personalize the learning content for the person with autism.

The user interface of FIG. 3B is shown containing screen 330, image 335, emoticon 340 and the description of the emotion 350.

Referring to FIG. 3B, in screen 330, the usermay select an imagefrom a collection of images on client system 160. In an embodiment, the user is required to upload facial images with different human emotions (e.g. sad, happy, surprised, etc). Server system 130 may then determine if a pre-defined human emotion (e.g. emotion depicted in 340) may be associated with the selected image. In the illustrative embodiment, the matching human emotion may be determined, for example, in a well known manner through Face API from Microsoft® Cognitive Services.

The input to the Face API is an image and the output contains, among other parameters, multiple human emotions, each with an associated percentage.

For example, when image 335 is presented to the API as input, the following is a part of the response provided by the API:

Detection result;
JSON:
[

{

“faceRectangle”: {

“top”: 114,
“left”: 212,
“width”: 65,
“height”: 65

```
  };
  “faceAttributes”: {
```

“emotion”: {

“anger”: 0.0,
“contempt”: 0.0,
“disgust”: 0.0,
“fear”: 0.0,
“happiness”: 1.0,
“neutral”: 0.0,
“sadness”: 0.0,
“surprise”: 0.0

}

}
},

]

Thus, server system 130 may store the selected image (335) in data store 120 along with the description of the closest-matching emotion 350 (‘Happy’).

In case no emotion with more than a threshold percentage (e.g. 80%) match is detected, an error message may be displayed to the user. Referring to FIG. 3C, in screen 360, when image 370 is provided (which is not a facial image), server system 130 may display error message 375.

In addition, the user may be provided with a user interface (not shown) to upload a voice sample in order to personalize the audio content.

It may be appreciated that the user may provide the personalization content (e.g. images and/or voice samples) at a later point in time, subsequent to adding the person with autism details, as shown in user interface 390 of FIG. 3D.

The description is continued to illustrate the manner in whichserver system 130 aids a person with autism in acquiring skills based on a corresponding learning program, according to aspects of the present disclosure.

5. Acquiring a skill through learning modules

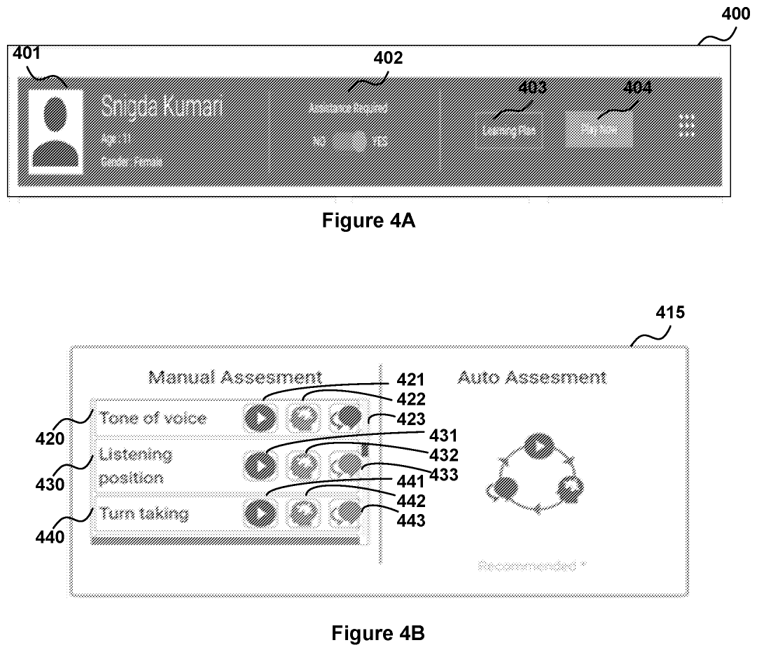

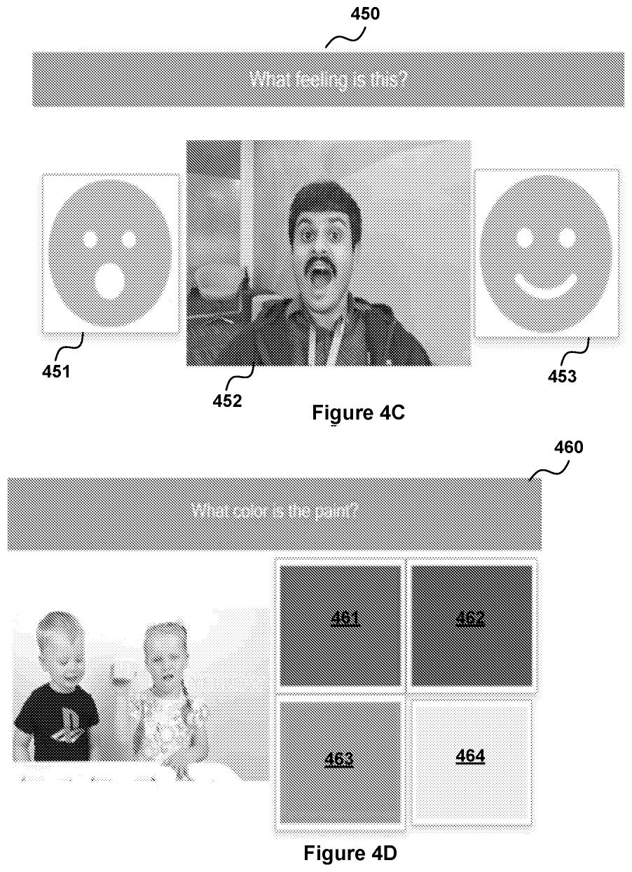

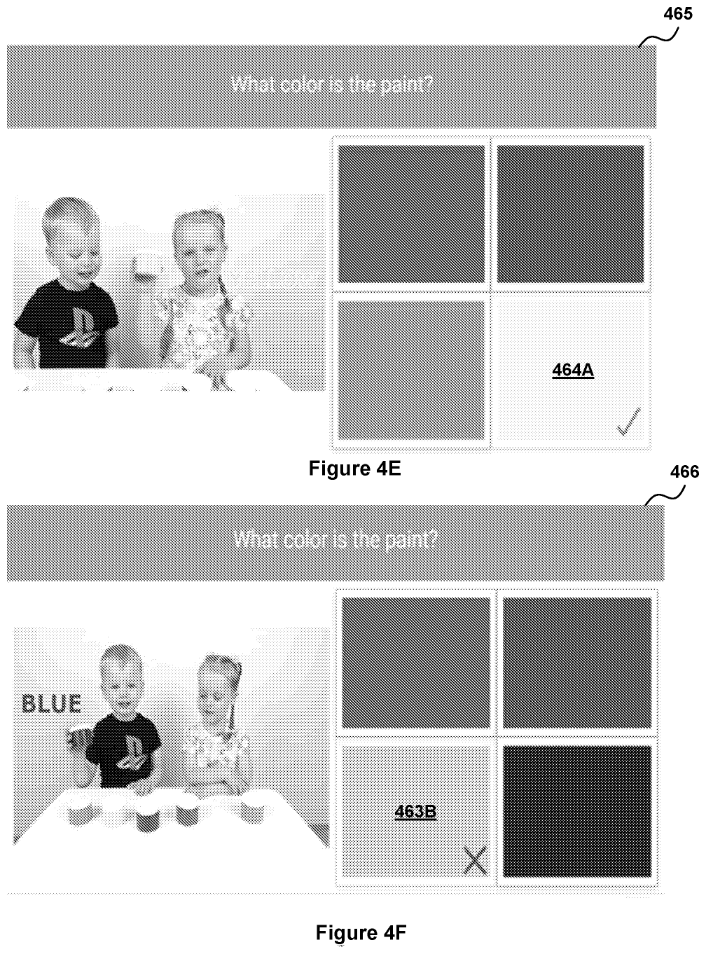

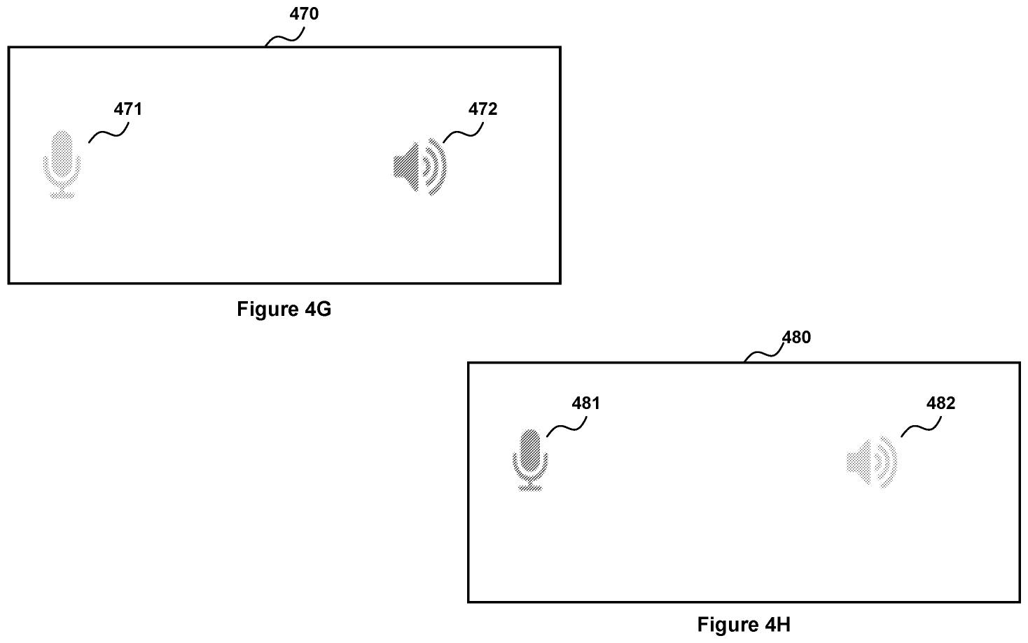

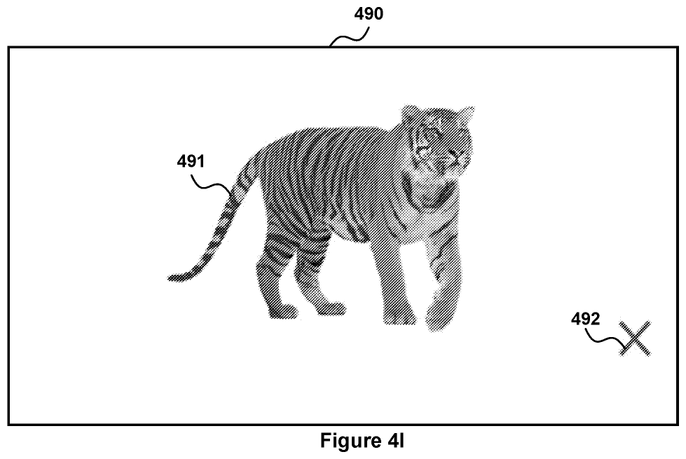

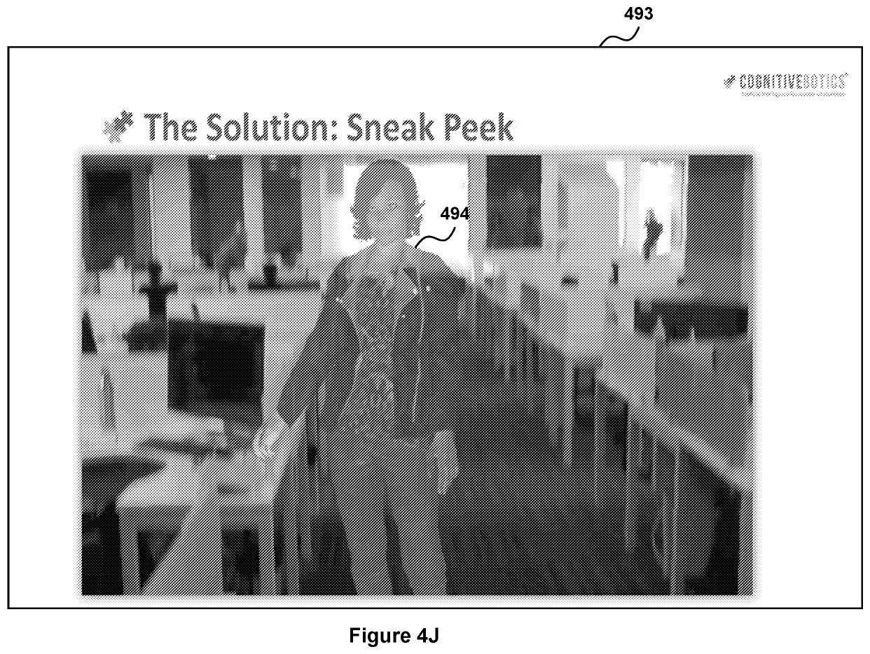

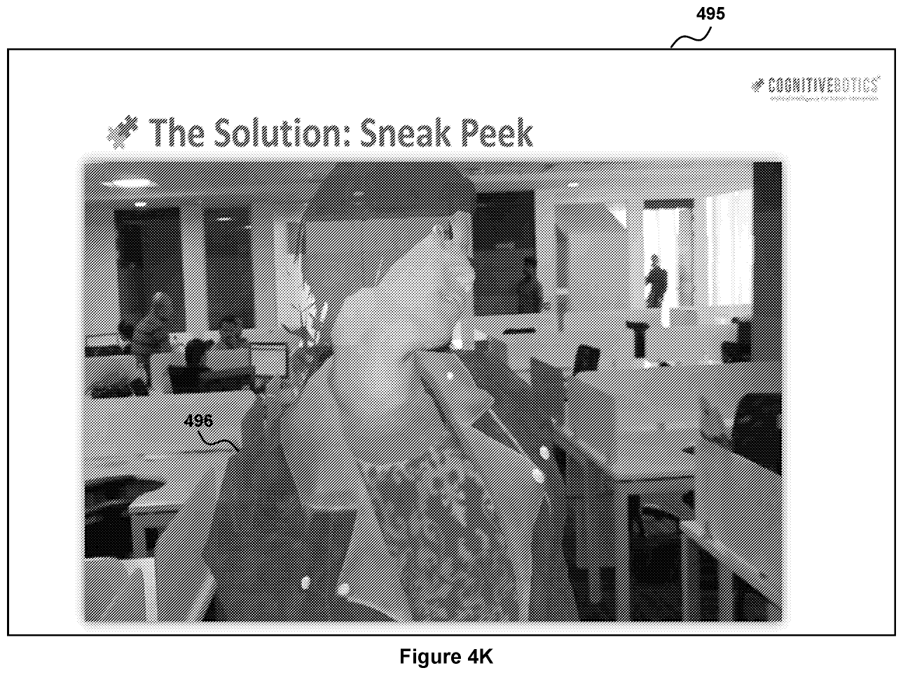

FIGS. 4A-4K depict sampleuser interfaces displayed on client system 160 to create a learning program for the user and to aid the user inacquiring a skill in an embodiment.

FIG. 4A depicts a portion of the user interface provided to guardian/therapist upon logging on to the technology based learning platform. Specifically, FIG. 4A is shown containing screen portion 400 with buttons ‘Assistance required’ (402), ‘Learning plan’ (403) and ‘Play now’ (404) for the selected user 401.

The guardian/therapist may use the toggle button ‘Assistance required’ (402) to indicate his/her assistance to the person with autism during a learning session. A ‘Yes’ (as depicted in FIG. 4A) indicates that the guardian/therapist assists the user during the learning session. A ‘No’ indicates otherwise.

Referring to FIG. 4A, when the user clicks ‘Learning plan’ button 403, the user may be redirected to a user interface (not shown) where a subset of skills suitable for the user may be identified from a superset/total list of skills available on the technology based learning platform. The superset of skills may also be classified into different categories (e.g. life skills, communication skills, etc). The subset of skills may be identified from different skill categories.

Server system 130 may create the learning program based on the skill set identified by the user. Alternatively, server system 130 may create the learning program for the person with autism based on the subscription category (e.g. basic/premium) and the mode of interaction (picture/text/audio) selected by the user. Server system 130 may determine an order of acquiring skills in the learning program as will be apparent from the disclosure below. Server system 130 may save the details of the learning program corresponding to the person with autism in data store 120.

When the guardian/therapist clicks ‘Play now’ button 404 depicted in FIG. 4A, the user interface of FIG. 4B is displayed.

FIG. 4B is shown containing screen 415 with text areas 420, 430, 440 and selectable icons 421, 422, 423, 431, 432, 433, 441, 442 and 443 under the sections ‘Manual Assessment’ and ‘Auto Assessment’. When the learning plan of the user has been configured by the guardian/therapist, only the ‘Manual assessment’ area of screen 415 may be available for selection. When server system 130 has created the learning plan for the user, only the ‘Auto assessment’ area of screen 415 may be available for selection. Alternatively, both the assessment types may be available to the guardian/therapist and the guardian/therapist may select any one, depending on the progress of the user.

Each text area represents a skill in the skill set identified for the user. In the illustrative embodiment, the skill set of the user is shown containing the skills ‘Tone of voice’ (420), ‘Listening position’ (430) and ‘Turn taking’ (440).

In the illustrative embodiment, each selectable icon represents a corresponding learning module associated with the skill. For example, on clicking selectable icon 421, the user is redirected to the concept module user interface. Similarly, on clicking selectable icon 422, the user is redirected to the games module and on clicking selectable icon 423, the user is redirected to the vocabulary module.

In an embodiment, each skill has certain pre-requisite skills. Server system 130 may retrieve the list of pre-requisite skills from data store 120.The pre-requisite skills may all belong to one category or different categories. Acquisition of pre-requisite skills may be mandatory for acquiring a new skill. Server system 130 may retrieve the progress of the person with autism from data store 120 and determine whether all the pre-requisite skills have been acquired.

For example, referring to FIG. 4B, the learning modules 421and 423 for skill ‘Tone of voice’ (420) are available as server system 130 has determined that the pre-requisite skills have already been acquired by the user.

When the guardian/therapist selects an icon, server system 130 renders the corresponding learning module user interface filling the entire display screen of client system 160. At this point, control of client system 160 may be handed over from the guardian/therapist to the person with autism.

Alternatively, when the guardian/therapist clicks ‘Play Now’ button 404 in FIG. 4A, server system 130 may directly display the user interface corresponding to the current learning module for the skill currently being acquired by the person with autism.

It may be appreciated that once the control of client system 160 has been handed over to the person with autism, there may be no other navigation controls (including a way to exit the screen) on the screen for the user. This may aid in engaging the user completely without any distractions. It may also be appreciated that the user interface may be presented in several different layouts based on the learning module and the progress of the user.

In an embodiment, the display screen may be one of a 2-way split screen (as shown in FIG. 4D), a 3-way split screen (as shown in FIG. 4C) or a full screen (as shown in FIG. 4G).

In an embodiment, each learning module may have corresponding levels where the user is progressively provided the levels based on a threshold percentage of success achieved in an individual level. The user may be taken to a previous level if the percentage of success falls below the threshold in a subsequent learning session.

In an embodiment, the user may need to achieve more than a threshold success percentage (e.g. 50%) in each learning module to progress to the next learning module of the skill. Server system 130 may compute the percentage of success in each module based on metrics such as time taken to give responses to interaction, number of attempts made at giving a correct response, number of audio and/or visual prompts required to elicit responses, number of repetitions of modules taken to give correct responses, attention span measured by time spent in actual engagement through touch/mouse/keystroke responses, etc.

In an embodiment, the learning modules for each skill include a concept module, a vocabulary module, a games module and an association module.

The concept module for a skill aids in introducing the concept of the skill and demonstrate what the skill looks like by using audio content and video content. The concept module may be interspersed with interactive quizzes.

In an embodiment, server system 130 may present a question with indication of a corresponding correct answer and prompt the user to select the correct answer by providing visual cues and audio prompts. The visual cues and audio prompts may vary in number and character depending on the current phase of skill acquisition. Server system 130 may keep track of the phase of skill acquisition by using various metrics, as will be described in great detail below.

In an embodiment, in an early phase of acquiring a skill, server system 130 may display and highlight only the correct answer on the screen. In subsequent phases, server system 130 may display additional options including the correct answer. The options may be displayed in a designated area on the display screen.

It may be appreciated that due to the learning disabilities of persons with autism, it may be difficult for the person with autism to select the correct answer even though only the correct answer is displayed on the screen. By providing various audio-visual cues, the person with autism is aided in selecting the correct answer.

The visual cues may include (but not limited to) blinking/animating/flickering the correct answer (even when only the correct answer is displayed on the screen), displaying the correct answer in a size different from rest of the options, etc. Server system 130 may record the responses of the user and the corresponding touch/clicks/keyboard strokeswith respect to the designated area for each question in data store 120 and use the same to monitor the progress of the user for each skill.

For example, server system 130 may provide user interface 4C as part of the learning modules for acquiring the skill of human emotion recognition. Specifically, emoticon 451 may be shown as blinking whereas emoticon 453 may not be shown as blinking to provide a visual cue for the correct answer corresponding to image 452 on screen 450. Server system 130 may record the response of the user in data store 120. Server system 130 may retrieve the matching emotion corresponding to the image 452 from data store 120.

Similarly, referring to FIG. 4D, color 464(correct answer) may be shown to be in a size smaller than the rest of the colors 461, 462 and 463 in screen 460.

When the user selects the correct answer, server system 130 may display a tick mark (as depicted for color 464A in FIG. 4E) and a cross mark (as depicted for color 463B in FIG. 4F) otherwise.

The various visual cues may be implemented by server system 130 in a known way.

Once the user has achieved the threshold percentage of success in the concept module for the skill, server system 130 may present the vocabulary module to the user.

The vocabulary module for a skill trains the vocabulary associated with the corresponding skill. The vocabulary may be trained via conversation or text, depending on the mode of interaction specified for the user. In an embodiment, server system 130 may implement the vocabulary module using speech recognition and natural language processing techniques.

In an embodiment, server system 130 may implement the vocabulary module using Chatbot. Specifically, Chatbot aids the user in eliciting responses by repeating the prompt/instruction several times. Chatbot also aids the user to improve the pronunciation of words in the vocabulary.

It may be appreciated that persons with autism may not be clear in their pronunciation. By applying natural language processing techniques, Chatbot aids to decipher the responses of the user.

In an embodiment, Chatbot receives the speech of the user as an input and converts the speech to text using Google speech-to-text converter (available at https://cloud.google.comispeech-to-text). The text is then compared against a set of valid values (e.g. words/phrases/sentences) corresponding to the expected response. Since the user may not be clear in pronunciation, a varied set of valid values is identified. Such varied set may include text corresponding to distorted or slurred versions of the expected response. The varied set of values for each user may be configured on the platform by the guardian/therapist and stored in data store 120.

For example, server system 130 may receive input from the user corresponding to the word “Yes”. However, the pronunciation of the user may correspond to the word “As”. The guardian/therapist may have provided the set of phrases including “Yes” and “As”. Server system 130 correctly interprets the word as “Yes” as described above.

Once the user has achieved the threshold percentage of success in the vocabulary module for the skill, server system 130 may present the games module to the user.

The games module may aid the user to internalize the skill using games. The concepts and vocabulary trained in the respective modules may be combined in the games module to re-emphasize the skill. In an embodiment, the games module employs artificial intelligence techniques to design games for the user.

Upon successful completion of the games module, server system 130 may optionally present the association module to the user.

The association module corresponding to a skill may aid to integrate the skill into real world experiences. Images and videos used in other learning modules may be two-dimensional in nature. However, real world objects are three-dimensional. Server system 130 simulates the real worldexperiences by depicting the images in three-dimensional form, where a depth of the visual content may be perceived by the user.

Server system 130 may implement the association module using mixed reality tools. In an embodiment, server system 130 may use Microsoft® HoloLens to simulate real world scenarios. HoloLens may comprise a head-mounted display and associated components such as holographic lens, depth-sensing camera, spatial sound speakers, sensors, etc. The user may wear the headset during interactions in the association module. Server system 130 may communicate with the processor on HoloLens using wired or wireless techniques (e.g. Bluetooth/Wi-Fi), as is well known in the relevant arts.

Server system 130 may provide the user inputs (e.g. images of familiar persons and/or objects) to HoloLens to create corresponding holograms. In an embodiment, HoloLens may create the corresponding hologram by using laser beams and holographic lens within the headset. The HoloLens may then project the hologram in the vicinity of the user. The user may then interact with the hologram through gaze, gesture and/or voice, as is well known in the relevant arts.

Thus, the association module aids in simulating real world experiences for the skill.

When a skill has been acquired by the user, server system 130 may present the next skill in the identified skill set for learning.

In an embodiment, server system may determine that a skill has been acquired by the user when the number of consecutive correct responses exceeds a predetermined threshold. However, alternative ways of determining that a skill has been acquired will be apparent to a skilled practitioner without departing from the scope and spirit of several aspects of the present invention, by reading the present disclosure.

It may be appreciated that for a person with autism, merely a total number of correct responses (including non-consecutive/random correct responses) may not be indicative of having acquired the skill. The user has to consistently give the correct responses for a skill over multiple repeated interactions for the corresponding skill on the technology based learning platform. Thus, a number of consecutive correct responses indicates that the user has really understood and acquired the skill.

It may also be appreciated that a learning module for a skill may be repeated several times in order to aid the user acquire the skill. Also, a learning module for an acquired skill may be revisited to reinforce the acquired skills.

Server system 130 may personalize the audio content and the visual content in the learning modules by using the inputs provided by the guardian/therapist as described below.

6. Personalization of audio content and visual content

Server system 130 may personalize the audio content in the vocabulary module by synthesizing the text corresponding to the audio content using the voice sample provided by guardian/therapist.

In an embodiment, server system 130 may employ GAN (Generative adversarial networks) to achieve personalization of audio content. The voice samples (provided by guardian/therapist) and the corresponding transcriptions are provided as inputs to GAN. GAN generates voice models from the given inputs, based on pronunciation of characters, phonemes and words in the voice samples. Further to this, the voice parameters of the generated models are used to synthesize a waveform for text corresponding to audio content.The speech synthesis may be implemented using a text-to-speech engine (e.g. Google text-to-speech converter, available at https://cloud. google. cornitext-to-speech) for voice personalization.

Alternatively or in addition, server system 130 may employ “Translatotron” from “Google” for achieving voice personalization (see details at https://ai.google.com/2019/05/introducing-translatotron-end-to-end.html). The personalization of audio content may be interleaved either apriori or on-the-fly.

For example, for a child with autism, the voice samples of his/her parent along with corresponding transcriptions may be provided as inputs to server system 130 on the technology based learning platform. Server system 130 may retrieve the text corresponding to audio content in the learning modules from data store 120 and generate the audio content for the child with autism in the parent's voice as described above.

It may be appreciated that persons with autism are more empathetic to voices of familiar people than voices of unfamiliar people. Further, it is more relevant for them to be able to respond to voices of real people in their lives and to learn the emotional cues in the voices of familiar people.Thus, the personalization of the audio content helps in creating a familiar environment for the user, thereby improving the engagement quotient of the user.

It may also be appreciated that persons with autism have limited attention spans, and also have difficulty directing their attention to an activity of their own volition. Hence, they need constant cues to stay focused on the activity and to help them be free of distraction. Thus, in an embodiment, server system 130 may prefix the interaction questions, prompts and instructions in each learning module with the name of the user (e.g.John).

Thus, the personalization of audio content by including the user name aids in drawing attention of the user back to the technology based learning platform. This may also remove any ambiguity the user might have as to who is expected to interact with/respond to the technology based learning platform.

Similarly, server system 130 may personalize the visual content in the learning modules such as the games module and the association module. For example, server system 130 may display the images of familiar persons (e.g. family members) or objects (e.g. a favorite toy of the user) uploaded by the guardian/therapist as part of the visual content. Also, server system 130 may provide such images to HoloLens to create corresponding holograms in the association module.

It may be appreciated that games need to be designed so that they are relevant to the real world of the user. Thus, the games are created such that inputs from the guardian/therapist (e.g. images of family members and/or objects familiar to the user) are used to personalize the content in the game.

The description is continued to illustrate the manner in which server system 130 provides the learning modules for acquiring the example skill of ‘establishing eye contact’.

7. Acquiring skill ‘establishing eye contact’

Eye contact helps people communicate their interest and attention. Establishing eye contact with others may be very challenging for persons with autism. The goal of this skill is to make the user establish eye contact.

Server system 130 starts with the concept module for the skill ‘establishing eye contact’. In the concept module of the illustrative embodiment, server system 130 plays a video for the userthat shows the location of eyes on a face accompanied by a brief description of the function of eyes. The video also shows a boy with open eyes along with an associated audio description ‘looking’. Similarly, the video also shows a boy with closed eyes along with an associated audio description ‘not looking’. Thus, the user is introduced to the concept of the ‘establishing eye contact’ skill by demonstrating that ‘eyes are for looking/seeing’.

As noted above, the concept module may be interspersed with interactive quizzes. For example, server system may pause the video, and display an image of eyes on the screen and the user may be asked to identify eyes by clicking on the image or touching the image (in case of a touch screen).

Once the user has achieved the threshold percentage of success in the concept module for the skill ‘eye contact’, server system 130 presents the vocabulary module to the user.

In an embodiment, server system 130 trains the vocabulary for the skill ‘establishing eye contact’ using conversation. Server system 130 displaysan image of a speaker and an image of a microphone on the display screenas part of the vocabulary module for ‘establishing eye contact’ skill. Referring to FIG. 4G, server system130 displays microphone image 471 and speaker image 472. Server system 130 generates the words “John, look” through the speaker by addressing the user with his/her name ‘John’.

Server system 130 may highlight speaker image 472 in a first color (different from the color of display of microphone image 471) when words in the vocabulary are generated through the speaker to indicate that the user is expected to listen. This is shown in user interface 470 of FIG. 4G. Similarly, as shown in user interface 480 of FIG. 4H, server system 130 highlights microphone image 481 in the first color to indicate that the user is expected to speak using a microphone.

Once the user has achieved the threshold percentage of success in the vocabulary module for the skill ‘establishing eye contact’, server system 130 presents the games module to the user.

In the games module of the illustrative embodiment, server system 130 provides visual content to the user along with background sounds and/or corresponding audio instructions to aid the user to make eye contact. For example, server system 130 may display an image and background sounds along with the instruction “John, look”. It may be appreciated that the games module may only include vocabulary associated with the skill introduced in the vocabulary module.

Server system 130 may receive input from client system 160 to detect whether the user is gazing at the image or not. Client system 160 in turn may employ a camera and machine learning/artificial intelligencetechniques in order to determine the gaze of the user.

As is well known, a gaze, as opposed to seeing/looking, may be understood as looking at something continuously for certain duration of time (e.g. 3 seconds) without blinking.

In an embodiment, posenet library (available at https://github.com/tensorflow/tfjs-models/tree/master/posenet) is employed to determine the gaze of the user. Specifically, video of the user is captured using the camera on client system 160. The captured video may be stored locally on client system 160. The locations of the pupils of the user are identified from the video frames using the API of posenet library, and a rectangular image (gaze co-ordinates) for each eye is extracted. The gaze co-ordinates are mapped to a corresponding area on screen of client system 160. The mapping is based on a calibration as described below.

Since the gaze co-ordinates represent the co-ordinates on the video frame, a calibration is required in order to determine the screen co-ordinates corresponding to the gaze co-ordinates. In an embodiment, the calibration is determined as an output of a ML model. The ML model is trained by collecting data obtained by showing targets to participants (groups of individuals) at known positions on the screen of client system 160. Data for eye images and corresponding screen co-ordinates is collected from the participantsworking on diverse devices (such as tabs, phones, desktops, etc.).The ML model converts device and eye image information into a co-ordinate on the screen of client system 160. The screen co-ordinates are then used to identify the area that the gaze is falling on and this is used to track the gaze of the user. Absence of lid movement in the successive video frames may be used to determine if the user is gazing at the screen.

It may be appreciated that the above technique of gaze detection is employed on the browser of client system 160 and may thus utilize less network bandwidth. Server system 130 may employ machine learning/artificial intelligencetechniques described above and provide the output of the ML model to client system 160.

It may be appreciated that the technique of gaze detection may be employed as part of learning modules of several skills on the technology based learning platform.

For example, in the association module of the skill ‘establishing eye contact’, client system 160 may display a ‘tick’ mark if the user is gazing at an image on the screen and a cross mark otherwise. This is illustrated in FIG. 41 where the user is assumed to not have gazed at image 491 on screen 490 and client system 160 has determined as such and hence displays cross mark 492.

Once the user has achieved the threshold percentage of success in the games module for the skill ‘establishing eye contact’, server system 130 presents the association module to the user.

In an embodiment, server system 130 may instruct the HoloLens to position the hologram in such a way that it is not in the direct line of vision of the user. Server system 130 may employ the gaze detection technique described above to estimate the line of vision of the user and provides the information to HoloLens. Next, server system 130 may provide an instruction to the user “John, look” through the spatial sound speakers of HoloLens such that the audio is presented to the user from the direction of the hologram. The user is then expected to turn in the direction of the hologram. HoloLens tracks the line of vision of the user and conveys the same to server system 130 to determine whether the user is able to turn in the direction of the hologram and look.

In this manner, server system 130 aids the user in acquiring the skill ‘establishing eye contact’.

The description is continued to illustrate the manner in which server system 130 provides the learning modules for the example skill ‘sitting tolerance’.

8. Acquiring skill ‘sitting tolerance’

Sitting tolerance is one of the early skills that needs to be developed in a person with autism. Sitting still for a period of time indicates a corresponding attention span of the user. The goal of this skill is to increase attention span of the user.

In the illustrative embodiment, server system 130 may combine the concept module and vocabulary module for this skill. Thus, server system 130 may play a video which depicts a child playing with some toys while seated on the floor.The video is gender specific, i.e. if the user is male, server system 130 plays a video with a boy as the central character.

Server system 130 may generate the names of the toys through the speaker on client system 160. In the interactive quizzes, server system 130 may display the image of a toy and the user is expected to respond with the name of the toy. Once the user has achieved the threshold percentage of success in the games module for the skill ‘sitting tolerance’, server system 130 presents the games module to the user.

In the illustrative embodiment, server system 130 provides a maze game for the user where the user is expected to move an object from one end of the maze to another using drag-and-drop feature. Once the user has achieved the threshold percentage of success in the games module for the skill ‘sitting tolerance’, server system 130 presents the association module to the user.

In the association module of the illustrative embodiment, server system 130 provides an image of familiar object to HoloLens. HoloLens creates the corresponding hologram and displays the same to the user.

In an embodiment, server system 130 may receive the height of the user (when standing) as an input from the guardian/therapist. Server system 130 may store this height, hᵤₛₑᵣ, in data store 120.

Server system 130 may also receive the following parameters as inputsfrom HoloLens:

1. Height (from floor) at which the hologram is displayed, h_{hologram}

2. Initial distance of the hologram from the user's eyes when the user is sitting, d_{hologram}

3. Initial angle made by the user's eyes with the hologram when the user is sitting, θ

Parameters (2) and (3) may be received as input at the start of the association module for this skill each time the association module is accessed. Alternatively, the parameters may be received the first time the association module for this skill is accessed and saved in data store 120 for subsequent instances of accessing the association module.

When the user interaction is in progress, h_{hologram} may remain constant whereas distance of the hologram from the user's eyes and angle made by the user's eyes with the hologram may vary if the user is moving around. HoloLens may measure distance of the hologram from the user's eyes and angle made by the user's eyes with the hologram at regular intervals and provide the values to server system 130. Server system 130 may compare the values received from HoloLens with the corresponding initial values, d_{hologram} and θ. If variation of either distance or angle or both exceed a threshold, server system 130 may conclude that the user is standing or moving around.

It may be appreciated that a certain range of motion is permissible to allow for swaying of user while sitting.

In an alternative embodiment, server system 130 may triangulate the height of the user (h′^{user}) using parameters h_{hologram}, d_{hologram} and θ, as is well known in the relevant arts. Server system 130 may compare hᵤₛₑᵣ (height of the user when standing) with h′ᵤₛₑᵣ and if the difference exceeds a threshold percentage, server system 130 may conclude that the user is sitting.

In another alternative embodiment, external cameras or lidar sensors may be employed to capture movement and determine whether the user is sitting or standing.

When server system 130 determines that the user is no longer sitting, server system 130 instructs HoloLens to stop displaying the hologram. In addition, server system 130 generates an instruction to remain seated (by audio prompt and/or visual cue) indicating that the user has to sit down. Server system 130 sets up a timer to aid the user understand how long he/she needs to be seated. Thus, server system 130 uses holograms of objects of interest as an incentive to increase the sitting tolerance of the user.

It may be appreciated that server system 130 may determine if the user is sitting as part of other learning modules as well.

In this manner, server system 130 aids the user in acquiring the skill ‘sitting tolerance’.

The description is continued to illustrate the manner in which server system 130 provides the learning modules for the example skill ‘how to greet’.

9. Acquiring skill ‘how to greet’

This skill teaches the user how to use body language and hand movements to greet a person.

In the illustrative embodiment, server system 130 teaches two greetings—‘Hi’ and ‘Bye’ as part of the skill, with the use of distinct body movement in the form of hand waving.

In the concept module, server system 130 plays a song and dance video to show the skill. The video is gender specific, i.e. if the user is female, server system 130 plays a video with a girl as the central character.

Server system 130 lets the user sing in karaoke style in the interaction part of the module, while watching the video of the dancing. In other words, the user has to intersperse his/her voice in the song sequence at the appropriate times as indicated by server system 130. Server system 130 determines the success based upon the user timing his/her voice to the video and using the appropriate greeting in the song sequence. For example, the total duration of the video may be 3min20seconds with ‘Hi’ greeting at time instances lminl5seconds and 2min35seconds. Server system 130 may accordingly pause the video at time instances lmin 15seconds and 2min 35seconds, and indicate to the user to respond with ‘Hi’ greeting. Server system 130 may proceed with playing the video only after the user has responded with ‘Hi’ greeting at the respective time instances. Alternatively, server system 130 may pause for fixed time duration (e.g. 5 seconds) and resume playing the video irrespective of the response provided by the user.The response provided by the user may be recorded by server system 130 to monitor the progress of the user.

In the vocabulary module, server system 130 provides a greeting to the user and the user is expected to respond back with the same greeting. Server system 130 uses the video clips of ‘Hi’ and ‘Bye’ greetings from the video of the concept module as visual prompts to aid the user to give the correct response.

In the games module, the user is expected match a video having greetings (with corresponding body movements) with the corresponding audio for the greetings. In the illustrative embodiment, server system 130 provides multiple video clips in respective display areas on the screen and corresponding audio clips to the user. The user clicks the audio clip and drags the correct audio clip to drop into the corresponding video area. Here, server system 130 includes several more ways of greeting and the user is expected to give correct responses to be able to complete the matching game successfully. There is no association module for this skill in the illustrative embodiment.

In this manner, server system 130 aids the user in acquiring the skill ‘how to greet’.

The description is continued to illustrate the manner in which server system 130 provides the learning modules for the example skill ‘tone of voice’.

10. Acquiring skill ‘tone of voice’

This skill teaches the user the appropriate tone of voice to use when speaking in a specific location. The user learns to distinguish between a whisper, a soft voice and a loud voice. The user also identifies the tone of voice corresponding to a specific location, e.g. the tone to use when in an open ground, a party scene, classroom, a prayer place etc.

In the illustrative embodiment, as part of the concept module, server system 130 plays a video depicting a wand. The wand is placed above head level to cue loud voice and below waist level to cue soft voice. Visual cues of lion, cat and mouse are used to symbolize loud voice, soft voice and whisper respectively. The characters in the video also place their hands in different positions to cue tone of voice. In the video of the illustrative embodiment, hands are placed open above the head for loud voice, around the mouth for soft voice and one hand to one side of the mouth to cue whisper.

In the vocabulary module of the illustrative embodiment, server system 130 displays pictures of different locationsto the user and the user is expected to respond with the correct tone to be used for the location. For example, an open ground may be displayed as being appropriate for a loud tone and a classroom may be displayed as being appropriate for a soft tone.

The user also has touse the tone for that word (e.g. say “loud” in a loud tone, “soft” in a soft tone and “whisper” should be whispered). Server system 130 determines if the correct tone is usedand if not, provides audio/visual cues to aid the user to respond in the correct tone. Server system 130 may store the location-to-tone mapping in data store 120.

In an embodiment, server system 130 may receive several voice samples representing respective ones of various tones (e.g. soft, loud, whisper). These voice samples, along with the corresponding labels for the tones, may then be provided to build a CNN (Convolution Neural Network) classifier using components in server system 130 (not shown).The CNN classifier may then classify a new voice sample (e.g. voice of the user).

For example, server system 130 may display the picture of an open ground. The user is expected to respond in a loud tone for the displayed location. Server system 130 may capture the audio response of the user via the microphone of client system 160. Server system 130 may then use the CNN classifier to classify the audio response as one of loud, soft or whisper. If the user has responded in a loud tone, server system 130 may indicate to the user that the correct tone has been used. If the user has responded in a whisper, server system 130 may indicate to the user that an incorrect tone has been used. In this manner, server system 130 determines if the correct tone is used.

In the games module of the illustrative embodiment, server system 130 provides an animation of a person walking in different locations with a corresponding tone of voice. In each location, the user has to choose the appropriate tone (from a set of answers displayed on the screen) that the animation will speak in. There is no association module for this skill in the illustrative embodiment.

The description is continued to illustrate the manner in which server system 130 provides the learning modules for the example skill ‘facial emotion recognition’.

11. Acquiring skill ‘facial emotion recognition’

This skill helps the user understand emotions, which is an important area of socializing and communication. One of the ways a person expresses their feelings is through the expressions on his/her face. The goal of this skill is to aid the user identify human emotions through facial expressions.

In the concept module of the illustrative embodiment, server system 130 displays the range of facial expressions used by people. With each facial expression, server system 130 associates a corresponding label describing the emotion.

In the vocabulary moduleof the illustrative embodiment, server system 130 trains the vocabulary associated with emotions/feelings by using words describing emotions such as happy, sad, surprised, etc.

In the games module of the illustrative embodiment, server system 130 checks whether the user is able to recognize the emotion of a person by observing the facial expression. Server system 130 may display the facial images of persons familiar to the user. Server system may also display a set of emotions. The user is expected to select an emotion that matches the emotion on the facial image. Server system 130 checks whether the selected emotion matches that on the facial image (as retrieved from data store 120 corresponding to the facial image). This is depicted in the user interface of FIG. 4C where server system 130 displays image 452 along with set of emotions 451 and 453. The user is expected to select 451 (“surprise”) to match the emotion with that on image 452.

Alternatively or in addition, server system 130 may display a set of facial images to the user for a specific emotion (e.g. happy) that the user is challenged to recognizeand the user is expected to select the facial image matching the specific emotion.

In an embodiment, emotions are introduced one at a time and the user progresses to the next emotion in the learning modules only after being able to recognize an emotion with a threshold percentage of success (e.g. correctly recognizing emotions 7 out of 10 times in a row). This ensures there is no confusion in the mind of the user regarding the facial expressions and the associated emotions. Server system 130 may repetitively present the learning modules for this skill to the user so that a greater range of facial expressions may be recognized and understood by the user.

It may be appreciated that personalization of content (e.g. facial images of family members) in this skill aids the user in understanding emotions of people in his/her real world by observing their facial expressions.

The description is continued to illustrate the manner in which server system 130 provides the learning modules for the example skill of ‘maintaining appropriate physical distance’.

12. Acquiring skill of ‘maintaining appropriate physical distance’

This skill teaches the user the amount of distance he/she should maintain when interacting with others. This skill also teaches the user the appropriate distance to maintain while making comfortable eye contact when speaking with others. Thus, it may be readily observed that the ‘eye contact’ skill is a pre-requisite for this skill.

In the concept module of the illustrative embodiment, server system 130 displays images of objects such as a carpet, a foot mat and a small rug. The images may be personalized for the user (e.g. the image may depict the user standing on the objects). The user would then be asked to choose an appropriate image to represent personal space corresponding to his/her age. For example, a child may need a personal space represented by the small rug whereas an adult may need personal space represented by the carpet. The age-personal space mapping may be stored in data store 120.When the user selects an image in response, server system 130 retrieves the age of the user from data store 120 and determines whether the response is correct. Alternatively, or in addition, the user may be asked to select an image appropriate to a particular situation. For example, when a user is interacting with family members, personal space represented by the foot mat may be sufficient whereas when the user is interacting with strangers, personal space represented by the carpet may be appropriate.

In the vocabulary module, server system 130 determines if the user is making eye contact with an image displayed on the screen. Server system 130 employs the gaze detection technique described above in order to determine the eye contact of the user. If server system 130 determines that the user is not making eye contact with the image, server system 130 instructs the user (by audio/visual cues) to make eye contact. Server system 130 may progress with the learning module only after the user makes successful eye contact.

It may be appreciated that persons with autism have limited attention span and have difficulty in gazing at objects on the display screen. By determining that the user is gazing at objects on the display screen and by drawing the attention of the user back to the screen by providing instructions, server system 130 aids in improving the ability of the user to gaze at objects on the display screen.

In the games module of the illustrative embodiment, server system 130 provides a game of basket ball to the user using HoloLens. A hologram of basket is projected in front of the user. The user is expected to move his/her hand within a predetermined space to aim and throw avirtual ball. If the user moves out of the space (either too far away or too near the basket, as determined by HoloLens and communicated to server system 130), the ball misses the basket. Server system 130 may then prompt the user to move in the correct direction to achieve the goal of aiming the ball to the basket. Alternatively, server system 130 may employ webGL/AR tools to implement the games module.

In the association module of the illustrative embodiment, server system 130 may provide the images of familiar persons to HoloLens to create corresponding holograms. HoloLens then displays the holograms to the user. HoloLens also determines the distance of the user from each hologram. When the distance is less than a minimum distance (the user approaches too close to the hologram), HoloLens communicates the same to server system 130. Then, server system 130 indicates to the user (e.g. by providing audio/visual cues) to increase the distance. Server system 130 may repeat the cues until the user increases the distance. Alternatively, HoloLens may communicate the measured distance to server system 130 and server system 130 may compare the distance with the minimum distance.

Referring to FIG. 4C, server system 130 employs user interfaces depicted in FIGS. 4J and 4K In the illustrative embodiment. FIG. 4J depicts a hologram 494 at a distance on screen 493 (as viewed through the HoloLens headset). When the user approaches a pre-defined minimum distance (the distance being determined by the HoloLens and communicated to server system 130) as depicted by 496 in screen 495 of FIG. 4K, server system 130 may generate a voice prompt asking the user to step back. Server system 130 may communicate the pre-defined minimum distance to HoloLens.

The description is continued to illustrate the manner in which server system 130 provides the learning modules for the example skill of ‘starting a conversation’.

13. Acquiring skill of ‘starting a conversation’

This skill trains the user to identify when it is appropriate to start a conversation. The goal of this skill is to build confidence of the user in socializing. This skill is a pre-requisite skill for progress to other skills in building a conversation.

In the concept module of the illustrative embodiment, server system 130 presents a video to the user that includes cues to identify when it is appropriate to start a conversation and actual method of starting a conversation.Server system 130 displays various conversation topics such as “Excuse me”, “Ask a question” and “Call friend's name”. For each conversation topic, server system 130 depicts a sample method to start the conversation. For example, to call a friend's name, server system 130 displays two persons in the video with one of them waving her hand and saying “Hi, Mike”.

In the games module of the illustrative embodiment, server system 130 displays images of objects corresponding list of words connected with the objects. The user is expected to select a certain number of words from the list. For example, server system 130 may display the image of an ‘apple’ and the words ‘red’, ‘fruit’, ‘sweet’ and ‘tree’. The user is expected to select 3 out of the 4 words that are directly connected to ‘apple’. Thus, a correct response from the user may be made by selecting ‘red’, ‘fruit’ and ‘tree’.

In an embodiment, the number of connected words may be increased as the user progresses through the levels of the games module. Words depicting direct and indirect connections with the object may be introduced. For example, a direct connection to ‘apple’ may be the word ‘tree’ and an indirect connection may be a new word that is connected to another word which has a direct connection to the object (e.g. ‘climb’, which is connected to ‘tree’).

In this manner, server system 130 aids the user in acquiring the skill ‘starting a conversation’.

The description is continued to illustrate the manner in which server system 130 provides the learning modules for the example skill of saying ‘I do not know’.

14. Acquiring skill of saying ‘I do not know’

This skill helps the user to become comfortable with saying “I do not know”. Most of the times, one does not know the outcome of a situation or an answer to a question. In persons with autism, this can lead to a feeling of panic. Allowing the person with autism to respond “I donot know” may help them avoid panic.

In the concept module of the illustrative embodiment, server system 130 presents a video to the user depicting scenarios where the user cannot predict the outcome of an event. Server system 130 depicts the situation where one person asks a second person a question. The second person responds by saying “I do not know”.

In the vocabulary module of the illustrative embodiment, server system 130 provides instances where the user learns to verbalize and use the phrase “I do not know” and also to learn where and when it is appropriate to use it. For example, server system 130 may ask the user “Will it rain today?” The user is expected to respond by saying “I do not know”.

In the games module of the illustrative embodiment, the user learns to associate gestures or body language with standard responses. Server system 130 first presents gestures or body language already known to the user. The user is expected to match the gesture with the corresponding meaning (e.g. the gesture made by connecting the thumb and forefinger in a circle and holding the other fingers straight signals the word okay, as is well known). Server system 130 then presents gestures which the user has not yet been trained in. The user is then expected to say “I do not know”

Thus, server system 130 operates to aid the user in acquiring skills of interest.

The description is continued to illustrate the manner in which server system 130 monitors the progress of the user for each skill on the technology based learning platform.

15.Monitoring progress

Server system 130 monitors the progress of the user for each skill each time the user accesses the technology based learning platform for a learning session as part of the corresponding learning module to acquire the skill.

Server system 130 may track several metrics in order to monitor progress of the user for each skill. Server system 130 may store the tracked metrics for the corresponding skill in data store 120. Server system 120 may implement measuring the metrics in a known way (e.g. with timers).

Server system 130 may track the following metrics for each learning session:

1. Duration of the learning session

2. Time taken to give responses

3. The number of audio prompts and visual cues needed to respond to interactions

4. The level of assistance needed during the session

5. The number of attempts made at giving a correct response

6. Attention span

7. The number of time-outs during the learning session

8. The number of consecutive correct responses

Server system 130 may then compute a cumulative progress for each skill based on the above metrics by calculating the following parameters:

1. The total number of attempts made in acquiring the skill

2. The total duration spent in acquiring the skill

3. The number of repetitions of each learning module taken in acquiring the skill

Server system may compute the attention span of the user during each learning session based on a meaningful interaction time, an irrelevant interaction time and an idle time. Server system 130 may measure the meaningful interaction time by counting the number of touch/mouse clicks/keystrokeswithin a designated area on the display screen during the learning session. Similarly, server system 130 may measurethe irrelevant interaction time by counting the number of touch/mouse clicks/keystrokesoutside the designated area on the display screen during the learning session. Further, server system 130 may measure the time spent with no interactions at all as the idle time during the learning session. In case the idle time exceeds a predefined threshold, server system 130 may exitthe user from the technology based learning platform (time out).

Server system 130 may determine the level of assistance needed during each learning session based on assistance being rendered to the user by the guardian/therapist during the learning session. Referring to FIG. 4A, the guardian/therapist may toggle the ‘Assistance required’ button 402 to indicate his/her assistance to the person with autism.

Server system 130 and/or guardian/therapist may alter the learning program based on the measured progress. In an embodiment, server system 130 may reduce the number of visual cues and audio prompts if the measured progress exceeds a pre-defined threshold of consecutive correct responses. Server system 130 may also change the mode of interaction (e.g. including text in addition to audio) based on the measured progress. Server system 130 may also alter the learning program to include pre-requisite skills.

It may be appreciated that instead of followingthelearning programconfigured in the initial set up, server system 130 operates to alter the learning program based on the progress of the user. This feedback-based learning process replicates a one-on-one intervention therapy session for persons having autism.

Thus, server system 130 may compute several progress metrics for each skill for each user, and all such metrics may be suitably communicated via a dashboard for convenient viewing by the guardian/therapist as described below.

16. Dashboard

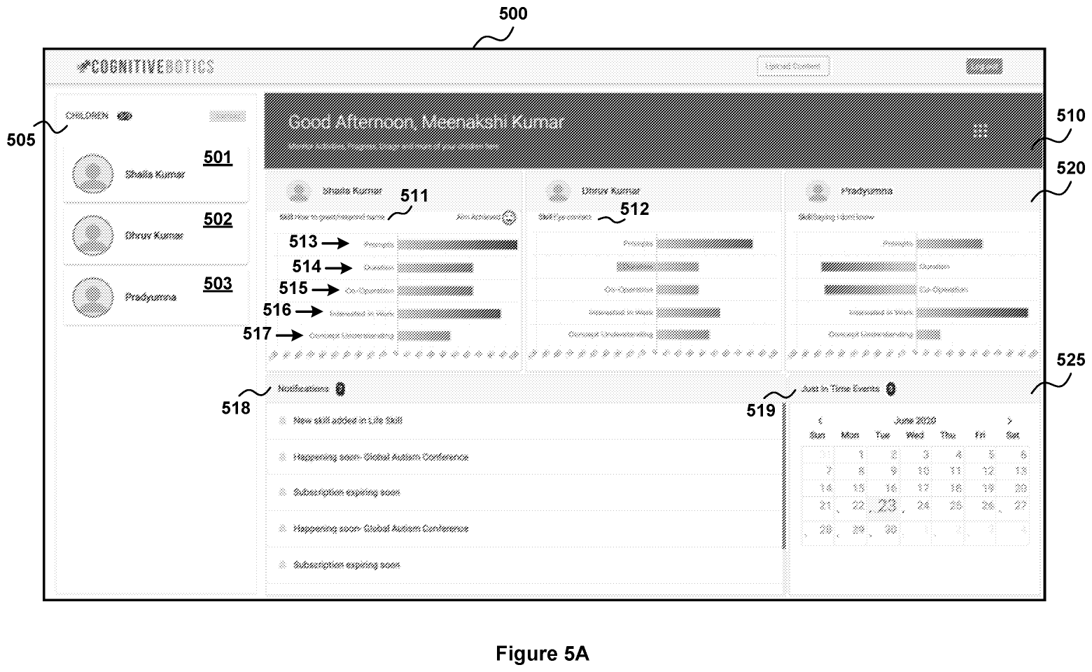

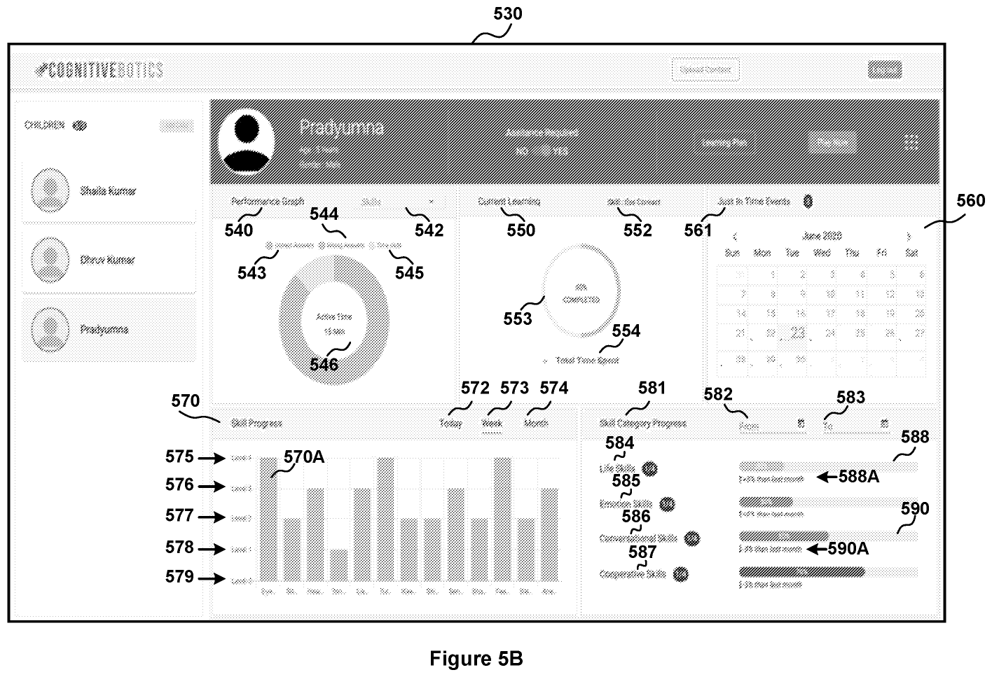

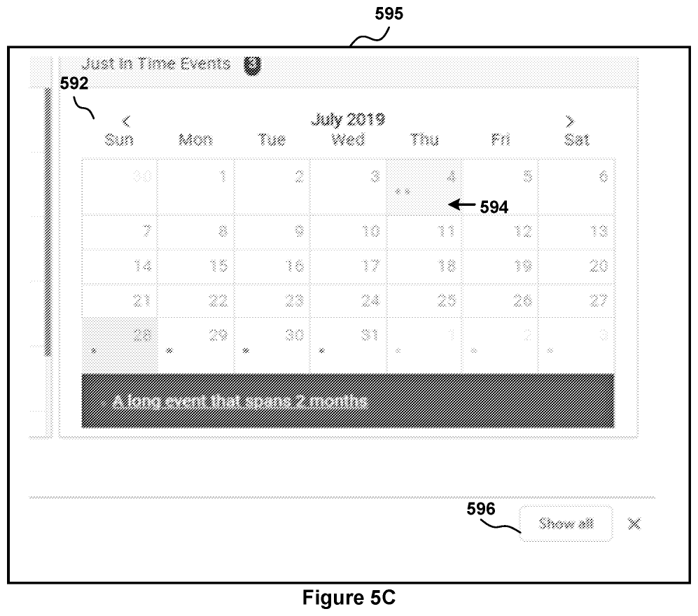

FIG. 5A depicts a sample summary dashboard displayed to guardian/therapist by server system 130 on client system 160.Server system 130 may display the summary dashboard of FIG. 5A to the guardian/therapist as soon as he/she logs in to the technology based learning platform. The respective metrics for the current skill for each person with autism associated with the guardian/therapist are shown communicated by a graph. Accordingly, an intuitive user interface is quickly provided for users.

FIG. 5A is shown containing screen 500 with display areas 505, 510, 520 and 525. It may be appreciated that the dashboard layout is merely for illustrative purpose. The dashboard may be displayed in several different screen layouts, as will be apparent to a skilled practitioner.

Display area 510 represents the details of the guardian/therapist and display area 505 represents the list of persons with autism associated with the guardian/therapist. Thus, referring to FIG. 5A, therapist ‘Meenakshi Kumar’ is shown to be associated with person with autism ‘Shaila Kumar’ (501), ‘Dhruv Kumar’ (502) and Tradyumna' (503). Each of the names in display areas 505 is a selectable link. Display area 520 displays the progress metrics for each person with autism for the current skill. Thus, labels 513-517 each represent a progress metric and the corresponding progress associated with the metric in the form of a bar graph. Specifically, progress metrics prompts (513), duration (514), co-operation (515), interested in work (516) and concept understanding (517) of each person with autism for the respective current skill are displayed in FIG. 5A, each of which is described below in further detail. Display area 525 is shown containing ‘notifications’ 518 and just-in-time events' 519. Notifications 518 represent any notifications intended for the user such as information about new skills acquired by associated person with autism; any upcoming events scheduled on the technology based learning platform, etc. Just-in-time events 519 represent upcoming real-life events scheduled by the user for the person with autism (described below in further detail).

For person with autism ‘Shaila Kumar’, the metrics are shown displayed for the skill ‘how to greet/respond’ (511) whereas for person with autism ‘Dhruv Kumar’, the metrics are shown displayed for the skill ‘eye contact’ (512). As can be seen from FIG. 5A, the metrics are displayed as percentages.

Each of the metric for the respective skill is explained below:

Prompts—This metric represents the total number of audio prompts and visual prompts provided by server system 130 to the person with autism to respond to interactions across all learning modules for acquiring the skill.

Duration—This metric represents the ‘attention span’ computed by server system 130 as described above (sum of meaningful interaction time, irrelevant interaction time and idle time across all learning modules for acquiring the skill)

Co-operation—This metric represents the difference between meaningful interaction time and sum of irrelevant interaction time and idle time. Thus, this metric may show a positive value when the meaningful interaction time exceeds the sum of irrelevant interaction time and idle time and a negative value otherwise.

Interest in work—The number of time-outs during each learning session gives a measure of the interest in the work.

Concept understanding—This represents the sum of the above four metrics (Prompts, Duration, Co-operation and Interest in work). When all metrics have positive values, the user is highly likely to complete a module and progress to the next module of the skill, and even complete all the modules of the skill and progress to the next skill. Completion of all modules indicates that the concept of the skill is grasped by the user. The measure of the metrics for all modules falling in the positive side of the scale indicates concept being understood.

The user may view further details corresponding to a person with autism for the current skill by clicking on name link of the person with autism. It is assumed that the user has selected person with autism ‘Pradyumna’ 503 by clicking on the corresponding link. Server system 130 displays the detailed dashboard of FIG. 5B depicting further progress details for the skill ‘eye contact’ for ‘Pradyumna’.

The detailed dashboard of FIG. 5B is shown containing screen 530 with display areas 540, 550, 561, 570 and 581. Display area 540 represents performance graph for a selected learning module 542. Display area 550 represents metric for current learning for current skill 552. Display area 561 represents just-in-time events. Display area 540 represents skill progress bar graph and display area 581 represents skill category progress.

Each display area of the detailed dashboard is described below in further detail.

Performance graph540 represents the progress metrics corresponding to a particular learning module (e.g. learning module 542, corresponding to the concept module) for the current skill. In the illustrative embodiment, the performance graph is shown in the form of a pie-chart. The pie-chart is shown containing the number of correct answers 543, the number of wrong answers 544 and the number of time outs measured 545 for the learning module. An active time 546(meaningful interaction time) may also be displayed.

Current learning metric 550 represents the percentage progress of the person with autism for the current skill. As shown in FIG. 5B, the person with autism has achieved 50% progress in the skill ‘eye contact’. This is also depicted in the form of a pie chart 553 in the illustrative embodiment.

Skill progress bar graph 570 represents the progress of the person with autism for each skill in the skill set in a particular time duration 572/573/574 (e.g. today/week/month). Thus, for skill ‘eye contact’ (570A), it may be observed that the person with autism has reached level 4 (575). As described above, each learning module may have several levels of learning.

Skill category progress 581 represents the progress of the person with autism across categories of skills 584 (life skills), 585 (emotion skills), 586 (conversational skills) and 587 (cooperative skills)in a selected time duration ('From'date 582, ‘To’ date 583) relative to a previous time duration. For example, in the category ‘Life skills’ (584), the person with autism has achieved a cumulative progress of 25% in the selected time duration (588), which includes an increase of 5% compared to the previous month (588A). The percentage progress may be computed based on the measure of the metricsdescribed above. Similarly, in the category ‘Conversational skills’ (586),the person with autism has achieved a cumulative progress of 50% in the selected time duration (590), which includes a decrease of 5% compared to the previous month (590A). It may be appreciated that although month has been depicted as the comparative time duration in the illustrative embodiment, such metrics can easily be obtained for other time durations as well (e.g. week) as will be apparent to a skilled practitioner.

It may be appreciated that the above approach is one of the ways of computing progress. However, alternative ways of computing progress based on several different metrics will be apparent to a skilled practitioner without departing from the scope and spirit of several aspects of the present invention, by reading the present disclosure.

It may also be appreciated the guardian/therapist may view the dashboard and monitor the progress of the user and be aware if the user is able to acquire a skill or not.All of these together give the guardian/therapist a picture of whether the user is able to interact actively and meaningfully with the technology based learning platform. Thedashboard metricsmay also be used to alter the learning program to cater to the need of the user by changing the content presentation and prompting methods. It may also help the guardian/therapist to choose a different mode of interaction (like audio or picture instead of text.). Thus, the feedback-based learning process replicates a one-on-one intervention therapy session for persons having autism.

The manner in which server system 130 aids in preparing the person with autism for upcoming real-life events is described below.

17. Just in time learning

To increase confidence and improve social interaction, the user may need to acquire new skills and/or repeat acquired skillsbefore an actual social event (e.g. a social gathering or a cultural event). Also, this process may need to be repeated each time a similar social event comes, and may take up to several iterations. To enable this, guardian/therapist may schedule such events in a calendar on the technology based learning platform.

FIG. 5C shows a user interface provided to guardian/therapist to schedule an upcoming event for the person with autism.

FIG. 5C is shown containing screen 595 with calendar control 592. The guardian/therapist may select a date on which the event is planned. For example, as shown in FIG. 5C, an event has been planned for 4th July 2019 (594). The event may be selected from a pre-defined set of events on the technology based learning platform. In addition, the guardian/therapist may also identify a set of skills needed for the scheduled event. Alternatively, based on the scheduled event, server system 130 may determine the set of skills needed for the scheduled event. In an embodiment, server system 130 may prioritize acquisition of the skills needed for the scheduled event and may thus alter the learning program for the user accordingly.

For example, if the skill ‘how to greet’ is required to be acquired by the user for the event, server system 130 provides the learning modules for the skill prior to learning modules for other skills in the learning program of the user. As noted above, server system 130 may also aid the user in acquiring the pre-requisite skills for each of the skill needed for the event. In this manner, server system 130 aids the user to prepare for real life scenarios.

Thus, server system 130 provides a technology based learning platform for persons having autism.

It should be appreciated that the features described above can be implemented in various embodiments as a desired combination of one or more of hardware, software, and firmware. The description is continued with respect to an embodiment in which various features are operative when the software instructions described above are executed.

18. Digital Processing System

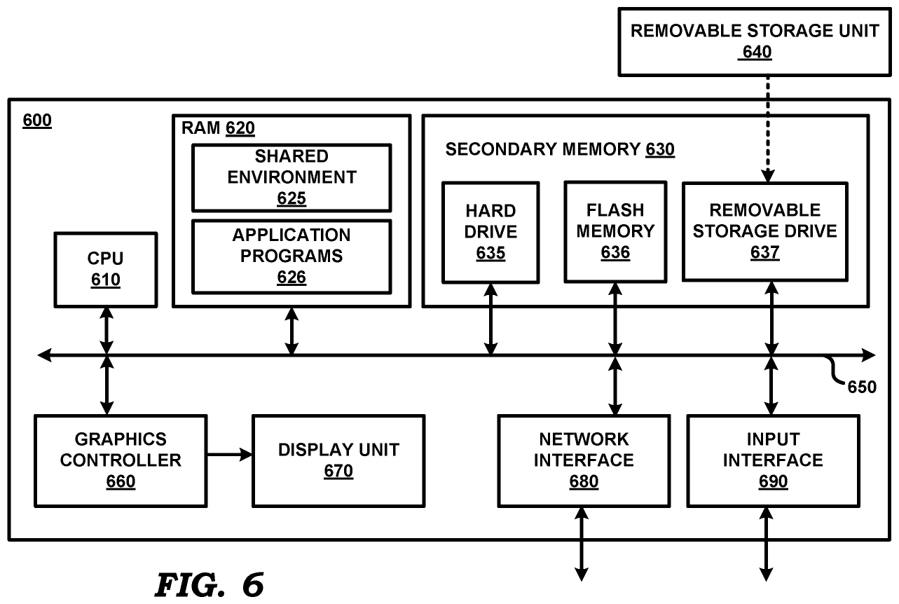

FIG. 6 is a block diagram illustrating the details of digital processing system 600 in which various aspects of the present disclosure are operative by execution of appropriate executable modules. Digital processing system 600 may correspond to one of client system 160 and server system 130.

Digital processing system 600 may contain one or more processors such as a central processing unit (CPU) 610, random access memory (RAM) 620, secondary memory 630, graphics controller 660, display unit 670, network interface 680, and input interface 690. All the components except display unit 670 may communicate with each other over communication path 650, which may contain several buses as is well-known in the relevant arts. The components of FIG. 6 are described below in further detail.

CPU 610 may execute instructions stored in RAM 620 to provide several features of the present disclosure. CPU 610 may contain multiple processing units, with each processing unit potentially being designed for a specific task. Alternatively, CPU 610 may contain only a single general-purpose processing unit. In addition, CPU 610 may be supported by CAM (content addressable memory) structures for examination of complex patterns.

RAM 620 may receive instructions from secondary memory 630 using communication path 650. RAM 620 is shown currently containing software instructions constituting shared environment 625 and/or other user programs 626 (such as the blocks of sever system 130 or client system 160 shown in FIG. 1). In addition to shared environment 625, RAM 620 may contain other software programs such as device drivers, virtual machines, etc., which provide a (common) run time environment for execution of other/user programs.

Graphics controller 660 generates display signals (e.g., in RGB format) to display unit 670 based on data/instructions received from CPU 610. Display unit 670 contains a display screen to display the images (e.g., images in learning modules including images depicted in FIGS. 4C-4I, dashboard of FIGS. 5A, 5B, etc) defined by the display signals. Input interface 690 may correspond to a keyboard and a pointing device (e.g., touch-pad, mouse) and may be used to provide inputs. Network interface 680 provides connectivity to a network (e.g., using Internet Protocol), and may be used to communicate with other systems (of FIG. 1) connected to the networks (110).

Secondary memory 630 may contain hard drive 635, flash memory 636, and removable storage drive 637. Secondary memory 630 may store the data (for example, images uploaded by user on server system 130, voice samples received from user, etc) and software instructions (for example, for implementing the various features of the present disclosure as shown in FIG. 2, etc.), which enable digital processing system 600 to provide several features in accordance with the present disclosure. The code/instructions stored in secondary memory 630 may either be copied to RAM 620 prior to execution by CPU 610 for higher execution speeds, or may be directly executed by CPU 610.

Some or all of the data and instructions may be provided on removable storage unit 640, and the data and instructions may be read and provided by removable storage drive 637 to CPU 610. Removable storage unit 640 may be implemented using medium and storage format compatible with removable storage drive 637 such that removable storage drive 637 can read the data and instructions. Thus, removable storage unit 640 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 640 or hard disk installed in hard drive 635. These computer program products are means for providing software to digital processing system 600. CPU 610 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 630. Volatile media includes dynamic memory, such as RAM 620. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 650. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

19. Conclusion

While various embodiments of the present disclosure have been described above, it should be understood that they have been presented by way of example only, and not limitation. Thus, the breadth and scope of the present disclosure should not be limited by any of the above-described exemplary embodiments, but should be defined only in accordance with the following claims and their equivalents.

It should be understood that the figures and/or screen shots illustrated in the attachments highlighting the functionality and advantages of the present disclosure are presented for example purposes only. The present disclosure is sufficiently flexible and configurable, such that it may be utilized in ways other than that shown in the accompanying figures.

Further, the purpose of the following Abstract is to enable the Patent Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present disclosure in any way.

What is claimed is:

1. A method for aiding person with autism to acquire skills, wherein the method comprises:
identifying a plurality of skills of interest for a user;
aiding the user in acquiring each skill of the plurality of skills;
monitoring progress of the user for each of the plurality of skills; and
providing a dashboard to display the progress of the user for the plurality of skills.

2. The method of claim 1, wherein the aiding in acquiring each skill comprises rendering an audio content and visual content for explaining the skill, for training a vocabulary associated with the skill and for simulating real world experiences for the skill.

3. The method of claim 1, wherein the aiding further comprises:
receiving a mode of interaction for the user, wherein the mode may be one or more of audio, picture and text; and
personalization of the audio content and the visual content.

4. The method of claim 3, wherein the personalization of the audio content further comprises:
receiving a name of the user;
receiving a voice sample of a person familiar to the user;
receiving text corresponding to the audio content;
synthesizing the text using the voice sample to form said audio content; and
prefixing interaction questions, prompts and instructions in the aiding with the name of the user.

5. The method of claim 3, wherein the personalization of the visual content comprises:
receiving a plurality of facial images of a person familiar to the user in different human emotions;
mapping the plurality of facial images to pre-defined human emotions; and
displaying the facial image of a desired human emotion of pre-defined human emotions when the desired human emotion needs to be expressed.

6. The method of claim 5, wherein the plurality of skills comprises human emotion recognition, wherein the aiding of acquiring the human emotion recognition skill comprises:
displaying a set of facial images of the plurality of facial images representing corresponding emotion of the person;
indicating a first emotion that the user is challenged to recognize;
receiving selection of one of the facial images of the displayed set of facial images;
checking whether the emotion of the selected facial image matches the first emotion.

7. The method of claim 2, wherein the simulating further comprises a virtual reality tool to simulate real world experiences.

8. The method of claim 7, wherein the plurality of skills comprises sitting tolerance, wherein the aiding of acquiring the sitting tolerance skill comprises:
creating a first hologram from a first image by the virtual reality tool;
displaying the first hologram to the user;
checking whether the user is sitting during a first time duration;
if the user is sitting, continuing to display the first hologram during the first time duration; and
if the user is not sitting, discontinuing to display the first hologram during the first time duration.

9. The method of claim 7, wherein the pluralityof skillscomprises maintaining appropriate physical distance, wherein the aiding of acquiring of maintaining the appropriate physical distance skill comprises:
creating a second hologram from a second image by the virtual reality tool;
displaying the second hologram to the user;
determining a distance of the user from the second hologram by the virtual reality tool;
indicating to the user to increase the distance if the distance is less than a minimum distance.

10. The method of claim 7, wherein the plurality of skills comprises establishing eye contact, wherein the aiding of acquiring the skill of establishing eye contact comprises:
creating a third hologram from a third image by the virtual reality tool;
determining a line of vision of the user;
displaying the third hologram to the user outside the line of vision;
instructing to the user to look at the third hologram; and
checking whether the user has looked in the direction of the hologram in response to the instructing.

11. The method of claim 2, further comprising:
displaying an object on a display screen;
detecting, using a camera, whether the user is gazing at the object;
if the user is detected to be gazing at the object, concluding that the user is progressing with the ability to gaze; and
if the user is detected not to be gazing at the object, indicate to the user to gaze the object.

12. The method of claim 2, wherein the aiding further comprises:
presenting a question with indication of a corresponding correct answer; and
prompting the user for the correct answer by providing visual cues and audio prompts.

13. The method of claim 12, wherein the presenting the question comprises:
displaying only the correct answer in an early phase of acquiring the skill and highlighting the correct answer;
displaying additional options including the correct answer in subsequent phases of acquiring the skill;
highlighting the correct answer in case of displaying additional options; and
displaying the correct answer in a size different from rest of the options.

14. The method of claim 1, wherein the monitoring comprises:
measuring a time taken to give responses during the aiding;
counting a number of correct responses of the user during the aiding,
counting a number of prompts required in acquiring the skill,
measuring a duration spent in acquiring the skill,
counting a number of time-outs during the aiding; and
determining a level of assistance needed in acquiring the skill.

15. The method of claim 14, wherein
the responses of the user are in the form of text, voice or picture selection;
the level of assistance is determined based on assistance being rendered to the user by a guardian or a therapist during the aiding;
the duration includes a meaningful interaction time, an irrelevant interaction time and an idle time, wherein
the meaningful interaction time is computed based on a count of touch, mouse clicks and keyboard strokes inside a designated area on the display screen in a second time duration;
the irrelevant interaction time is computed based on a count of touch, mouse clicks and keyboard strokes outside the designated area in the second time duration.

16. The method of claim 1, whereinthe monitoring further comprises altering the aiding process based on the progress of the user, wherein
the altering comprises reducing the number of visual cues and audio prompts if the progress exceeds a pre-defined threshold of consecutive correct responses, and
changing the mode of interaction.

17. The method of claim 1, wherein each skill is determined to be acquired based on a threshold number of consecutive correct responses during the aiding.

18. The method of claim 1, wherein the aiding further comprises:
receiving a date for an event;
receiving a first set of skills required to be acquired by the user prior tothe date; and
adding the first set of skills to the plurality of skills of interest,
wherein said aidingoperates to help the user to acquire the first set of skills prior to other skills.

19. A non-transitory machine readable storage medium storing one or more sequences of instructions for aiding person with autism to acquire skills, wherein execution of the one or more instructions by one or more processors contained in a digital system enables the digital system to perform the actions of:
identifying a plurality of skills of interest for a user;
aiding the user in acquiring each skill of the plurality of skills;
monitoring progress of the user for each of the plurality of skills; and
providing a dashboard to display the progress of the user for the plurality of skills.

20. A central server comprising:
at least one memory unit to store instructions; and
at least one processor to execute the instructions to cause said central server to perform the actions of: identifying a plurality of skills of interest for a user;
aiding the user in acquiring each skill of the plurality of skills;
monitoring progress of the user for each of the plurality of skills; and
providing a dashboard to display the progress of the user for the plurality of skills.
